(19) United States
(12) Patent Application Publication
(10) Pub. No.: US 2016/0168878 A1
(43) Pub. Date: Jun. 16, 2016

(54) FOOT PEDAL ASSEMBLY FOR APPLIANCES

(71) Applicant: Heather A. Fischer, Morris Plains, NJ (US)

(72) Inventor: Heather A. Fischer, Morris Plains, NJ (US)

(21) Appl. No.: 14/966,049

(22) Filed: Dec. 11, 2015

Related U.S. Application Data
(60) Provisional application No. 62/090,518, filed on Dec. 11, 2014.

(51) Int. Cl. E05B 65/06; D06F 58/20; D06F 37/42

(52) U.S. Cl. CPC E05B 65/06; D06F 37/42; D06F 58/20

(57) ABSTRACT

An appliance is provided incorporating a foot pedal assembly, the appliance comprising a door frame having a catch for a latch, a door with a strike for mating with the catch, a foot pedal for causing the release of the strike from the catch, the pedal mounted external to a housing of the appliance, and a mechanical linkage connecting the foot pedal to the catch, where actuating the foot pedal causes the strike to be released from the catch.

### CROSS REFERENCE TO RELATED APPLICATIONS

This application claims the benefit of Provisional Application No. 62/090,518, filed Dec. 11, 2014, the contents of which are incorporated by reference herein.

### FIELD OF THE INVENTION

The invention relates to a foot pedal assembly for releasing a strike from a catch in appliances in order to ease the opening of the appliance.

### BACKGROUND

Many appliances must be kept firmly closed when in use in order to properly utilize the function of such appliances. For example, washing machines must be kept firmly closed in order to prevent water from leaking out of the machine during use, and dryers must be kept firmly closed in order to prevent the machine from opening under any forces associated with the drying activity therein. For example, a drying machine must remain closed when its rotating drum forces clothing against a door of the machine with force. Further, such appliances must remain firmly closed when not in use in order to prevent children and the like from climbing into a basin of such a machine.

Accordingly, safety and usability concerns often require that doors to such appliances close and be retained in a closed position with greater force than a typical cabinet, requiring significant pulling force from a user in order to open the machine. Unfortunately, some users are unable to apply the required pulling force to the door of such a machine. For example, arthritic users may be unable to apply significant opening force to overcome a latching force in such appliances, and may therefore be unable to perform household tasks simply because they are unable to open and close appliances.

Some modern appliances, such as washing machines use electrical latches to lock the door of such appliances and release at the end of a cycle in order to allow a user to open such a machine. Such latches often add unnecessary complications to appliances and may be difficult to control.

There is a need for an efficient mechanism for easing the opening of appliances without sacrificing the firm closure required for such appliances for the sake of safety and functionality.

### SUMMARY

An appliance is provided incorporating a foot pedal assembly, the appliance comprising a door frame having a catch for a latch, a door with a strike for mating with the catch, a foot pedal for causing the release of the strike from the catch, the pedal mounted external to a housing of the appliance, and a mechanical linkage connecting the foot pedal to the catch, where actuating the foot pedal causes the strike to be released from the catch.

### BRIEF DESCRIPTION OF THE DRAWINGS

FIG. 1 is a perspective view of a front loading appliance incorporating a pedal mechanism.

FIG. 2 is a perspective view of the appliance of FIG. 1 with the door shown open and with a portion of the front surface of the machine shown as transparent.

FIG. 3 is a sectional view of a latch mechanism and mechanical linkages in the appliance of FIG. 1.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

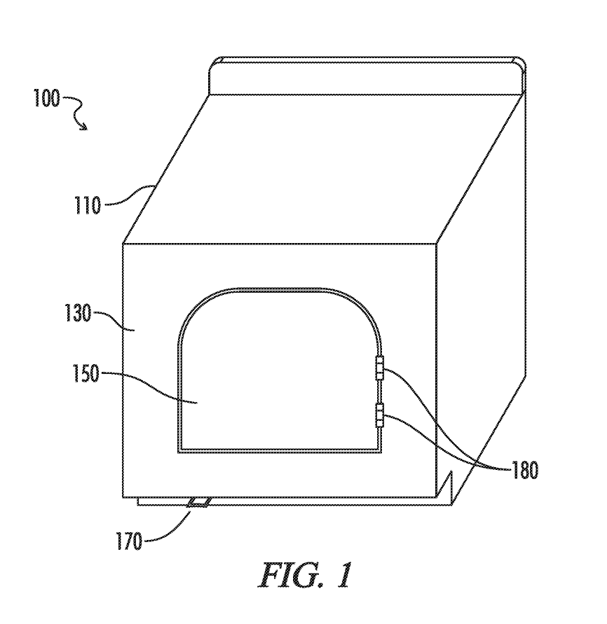

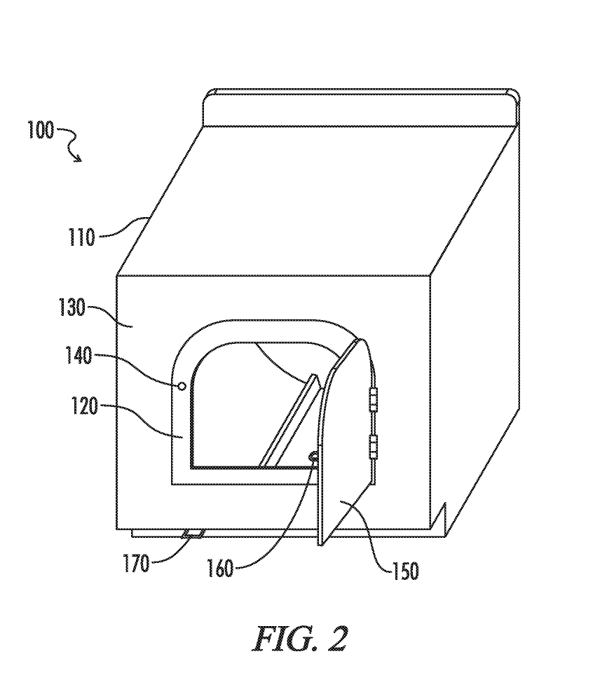

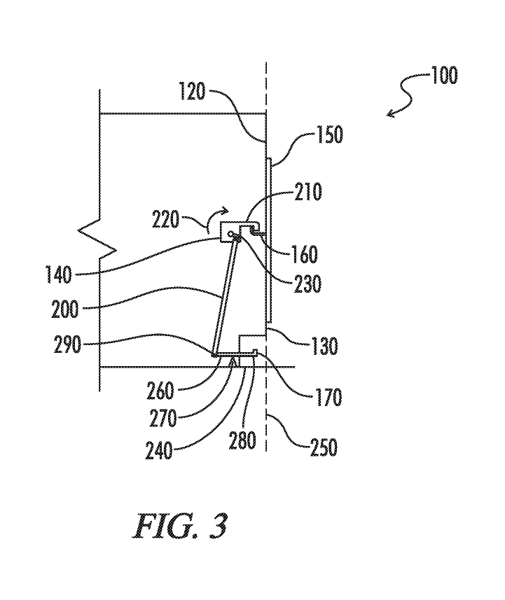

FIGS. 1 and 2 show a perspective view of a front loading appliance 100 incorporating a foot pedal assembly and FIG. 3 shows a sectional view of a latch comprising a catch 140 and a strike 160 and mechanical linkages 200 in the appliance. In the embodiment shown, the front loading appliance is a drying machine, but it is understood that such an assembly may be similarly applied to a wide variety of appliances, including washing machines. The appliance 100 has a housing 110 which supports the foot pedal assembly and maintains the various components in position relative to each other. In some embodiments, an appliance has a housing to which a foot pedal assembly may be retrofitted such that the assembly may be installed as a kit, either on a generic appliance, or on an appliance designed for accepting such a retrofit kit.

The foot pedal assembly in the appliance 100 comprises a door frame 120 in a front surface 130 of the appliance 100 carrying a catch 140 for a latch, a door 150 attached to the door frame 120 carrying a strike 160 for a latch, a pedal 170 for releasing the strike from the catch, and a mechanical linkage connecting the foot pedal to the catch.

The door 150 swings through a substantially horizontal plane about a vertical axis on hinges 180 in order to open and close with respect to the door frame 120. When the door 150 is closed with respect to the door frame 120, it is secured by the latch to the door frame 120 on the end of the door opposite the hinges 180. In some embodiments, the hinges 180 apply a bias to the door 150 such that the door opens 150 when the catch is released using the foot pedal 170.

Although a front loading door is shown such that the door swings across a substantially horizontal plane, the door may be hinged on the bottom of the door, such that door rotates away from the door frame on a horizontal axis. In other embodiments, the appliance may be a top loading appliance and a bias in the hinges is sufficient, or nearly sufficient to overcome the weight of the door. In such embodiments, the door frame may be in a top surface of the appliance. In any of these configurations, a catch for a latch is mounted in the door frame, and a strike retained within the catch may be released by actuating the foot pedal.

The latch comprises a catch 140, installed in the door frame 120, and a strike 160 for mating with the catch, mounted on the door 150. The latch may be of a grab catch type, where the catch 140 retains the strike 160 until the catch is opened by an actuator, in this case, the mechanical linkage 200. Such a grab catch 140 may retain the strike 160 any time the strike contacts the catch with sufficient force. The grab catch 140 may then retain the strike 160 until released using the foot pedal 170.

In some embodiments, the grab catch 140 may be a spring loaded latch 210, such that when the pedal 170 is actuated, the mechanical linkage 200 moves the catch in opposition 200 to a spring force 220. For example, the spring loaded latch 210 may be rotated about an axis 230 by the force of a spring 220 in order to secure the strike 160, and when the foot pedal 170 is actuated, the mechanical linkage 200 may apply force in opposition to the spring force 220 in order to rotate the catch about the axis 230 in the opposite direction.

The pedal 170 is mounted on the external of the appliance 100, and is mounted near the bottom of the front surface 130 of the appliance. In some embodiments, the base of the appliance may be recessed 240, and the foot pedal may be provided in the recess such that the foot pedal does not stick out beyond a front surface 250 of the overall profile of the appliance.

The pedal is connected to a mechanical linkage 200 internal to the housing of the appliance, the mechanical linkage connecting the foot pedal 170 to the catch 140 of the latch. Accordingly, actuating the foot pedal 170 by, for example, compressing the pedal, will cause the strike 160 to be released from the catch.

In some embodiments, the mechanical linkage 200 may be forced upward in order to release the strike 160 from the catch 140. In such embodiments, the pedal may be connected to a secondary mechanical linkage 260 with a first end 280 connected to the pedal 170 and a second end 290 connected to the mechanical linkage 200 and which reverses the direction of force applied to the pedal 170. This may be, for example, by utilizing a fulcrum 270 such that when the pedal forces a the first end 280 of the secondary mechanical linkage 260 downward, the fulcrum 270 causes the second end 290 of the secondary mechanical linkage, carrying the mechanical linkage 200, to move upward, thereby releasing the catch 140 of the latch.

In other embodiments, a simplified mechanical linkage may be utilized to pull a portion of the catch downwards when the pedal is compressed. In such an embodiments, the downward motion of the pedal may be applied directly to the mechanical linkage. A simplified mechanical linkage may be, for example, a cable linkage tensioned in opposition to a spring force in the catch. Such a cable linkage may provide additional flexibility for the location of the catch with respect to the pedal. Such flexibility may ease the implementation of the pedal assembly as a retrofit, for example.

The pedal 170 may be installed directly below or offset from the catch 160 for the latch, such that the mechanical linkage 200 connecting the pedal to the catch lies along a substantially vertical axis. In some embodiments, the catch 160 may be provided elsewhere on the appliance, such as when the door 150 opens differently than in the configuration shown, or where the door is on the top surface of the appliance. In such an embodiment, the mechanical linkage 200 may be a cable linkage in order to redirect the pedal force as needed.

In some embodiments, a pedal lock is provided to prevent the pedal 170 from being compressed. Such a pedal lock may be engaged when the appliance is in use to prevent the appliance from being opened inadvertently. The pedal lock may further be applied such that the appliance cannot be opened by children or when otherwise unintended. In some embodiments, rather than preventing the pedal 170 from being compressed, the pedal lock may disconnect one or more linkage, such that when the pedal is compressed, the catch 140 does not release the strike 160.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An appliance comprising:
a) a door frame having a catch for a latch;
b) a door with a strike for mating with the catch;
c) a foot pedal for causing the release of the strike from the catch, the pedal mounted external to a housing of the appliance; and
d) a mechanical linkage connecting the foot pedal to the catch,
e) wherein actuating the foot pedal causes the strike to be released from the catch.

2. The appliance of claim 1, wherein the latch is a grab catch, and wherein actuating the pedal causes the catch to open.

3. The appliance of claim 1, wherein the latch is a spring-loaded latch, and wherein actuating the pedal moves the catch in opposition to the spring.

4. The appliance of claim 3, wherein the catch is rotated about an axis in a first direction to secure the strike, and wherein actuating the pedal rotates the latch about the axis in a direction opposite the first direction.

5. The appliance of claim 1, wherein the mechanical linkage is inside the housing of the appliance, and wherein a downward pivoting of the pedal causes a substantially upward movement in the mechanical linkage.

6. The appliance of claim 5, wherein the mechanical linkage comprises a first linking element for changing the direction of a force applied to the pedal from downward to upward, and a second linking element for transmitting force from the first element to the latch.

7. The appliance of claim 6 wherein the second element lies along a substantially vertical axis.

8. The appliance of claim 1, wherein the mechanical linkage is inside the housing of the appliance, and wherein a downward pivoting of the pedal causes a substantially downward movement in the mechanical linkage.

9. The appliance of claim 1, further comprising a hinge for mating the door to the door frame allowing the door to pivot relative to the door frame, wherein the hinge biases the door such that the door opens when the strike is released from the catch.

10. The appliance of claim 1 wherein the door frame is on a front surface of the appliance.

11. The appliance of claim 1 wherein the door frame is on a top surface of the appliance.

12. The appliance of claim 1, further comprising a pedal lock such that when the pedal lock is engaged, the pedal cannot be compressed in order to release the catch.
